(19) United States
(12) Patent Application Publication
(10) Pub. No.: US 2006/0043188 A1
(43) Pub. Date: Mar. 2, 2006

(54) Imaging method and apparatus for object identification

(76) Inventor: Gregg Kricorissian, Ottawa (CA)

Correspondence Address: PEARNE & GORDON LLP, 1801 EAST 9TH STREET, SUITE 1200, CLEVELAND, OH, 44114-3108, US

(21) Appl. No.: 10/927,695

(22) Filed: Aug. 27, 2004

(51) Int. Cl. G06K 7/10

(52) U.S. Cl. 235/462.08; 235/470

(57) ABSTRACT

The system for identifying objects comprises an imaging system, such as a CMOS imager or a CCD camera, for capturing images of the objects and for identifying certain objects from the captured images. An external processor, which is coupled to imaging system by a high-speed communications link, is adapted to identify objects from the captured images that are transmitted to it by the imaging system. The imaging system thus captures images of the objects passed by it and then identifies certain of the objects from the images due to its processing capacity. The external processor with its superior processing capacity identifies the objects from the captured images transmitted to it by the imaging system. The imaging system may be adapted to transmit the captured images of the objects that it cannot identify or to transmit all of the captured images of the objects to the external processor for parallel processing. The targets for the imaging system may be one or more regions of interest on the object such as symbology, barcodes, text, graphics or shapes.

### FIELD OF INVENTION

The present invention relates generally to a method and apparatus for object identification, and more particularly to an imaging method and apparatus for processing images on two levels for object identification.

### BACKGROUND OF THE INVENTION

Currently, image recognition software and image readers are used in a number of industrial settings including use in a high-speed conveyor belt to identify objects by shape or by markings on them. These systems are used for object inspection, failure analysis, and package sorting.

In an object inspection or failure analysis system, objects are placed on a conveyance and brought in front of a fixed mount electronic camera where the object is photographed, the image is then processed by image recognition software that compares the image to template of a passable form factor. The inspection system then determines whether the object passes the inspection, and then either sorts it to an exception bin, or passes it on as approved. An alternative to this system is a human inspector performing the same task

Both of these solutions have their limitations; in the first, the system may fail the object even though it is readily identifiable due to the object being placed incorrectly on the conveyance; in the second the human inspector will be slower than the computer inspection system, and may also introduce human error.

In a package sorting system, the markings on the object often include package address labels that contain symbology, such as bar codes both one-dimensional (code 39) and two-dimensional (PDF417, DataMatrix, MaxiCode, and the like), typed or hand-written address information, as well as graphic symbology such as logos and the like. These packages could be envelopes or parcels as in a mail sorting system used by postal or courier services. Packages enter the system and are scanned. If the information on the address label is unreadable, the package is placed in an exception handling system, which could be a bin or another conveyor belt. An operator would then read the address block and manually enter the information to make a new label. Alternately, a closed circuit television (CCTV) system (or similar system using a video camera) may be used whereby an operator views the entire package on a video screen. The operator visually identifies the addressing information on the video screen and generates a new label to be placed on the package.

Both of the above-described methods can introduce human error. The CCTV system may also suffer from poor image quality since basic video cameras are generally used which do not have any significant processing capabilities. These cameras generally view a large area of the package and do not limit the field of view to the address block. Further, these exception-handling systems tend to introduce human error by relying on an operator to read and reroute packages that have been flagged.

In an archiving system a human operator will inspect the material to be archived (i.e. books, pictures, or other objects) and manually enter the descriptive information about the material. This approach is cumbersome, and may lead to human error when dealing with data entry.

Well known in the art is image recognition software which is capable of identifying difficult to read or damaged bar codes. However, this method is intensive and requires substantial computing power.

Another method known in the art incorporates an image reader system with compression software to allow the image reader to communicate with an external, more powerful processor. This solution however, introduces time delays for compression and decompression of the image. Compression also reduces image quality, which may remove important information from the image.

Therefore there is a need for an object recognition system, which is capable of a high degree of speed and accuracy in identifying objects reducing the need for manual data entry in an object inspection system.

### SUMMARY OF THE INVENTION

The present invention is directed to a system and method for identifying objects wherein the system comprises an imaging system for capturing images of the objects and for identifying certain objects from the captured images, an external processor for identifying the objects from the captured images, and a high speed communications link coupling the imaging system and the external processor for carrying captured image data from the imaging system to the external processor. The method of identifying objects comprises passing the objects before the imaging system, capturing images of the objects, directing the imaging system to identify certain of the objects from the images, transmitting images of the objects to the external processor and directing the external processor to identify the objects from the transmitted images.

More specifically, the imaging system may be adapted to transmit the captured images of the objects unidentified by the imaging system to the external processor, or to transmit all of the captured images of the objects to the external processor.

In accordance with another aspect of this invention the imaging system comprises an image sensor, an image processor, a high speed port, and a bus linking the sensor, image processor and the port. The imaging system can further include a memory for storing the captured images, a memory for storing application software and a user interface. The entire imaging system may be contained in a handheld unit.

In accordance with a further specific aspect of this invention, the imaging system may be an electronic camera such as a CMOS imager or a CCD camera.

In accordance with a further aspect of this invention, the method of identifying objects comprises passing the objects before the imaging system, capturing images of the objects, identifying certain of the objects by the imaging system from the captured images, transmitting the images of the unidentified objects to the external processor and identifying the unidentified objects by the external processor.

In accordance with yet another aspect of this invention, the method of identifying objects comprises feeding objects into the identification system, scanning the objects to capture images of the objects, attempting to identify the objects from the captured images, directing the objects of the identified images out of the system, directing the remaining unidentified images to the external processor, attempting to identify the remaining images by the external processor, and directing the objects of the identified remaining images out of the system.

In accordance with a further specific aspect of this invention, labels are printed for the objects of the identified remaining images and an operator is notified of objects unidentified by the external processor. Further the objects may have regions of interest and may be symbology, barcodes, text, graphics or shapes.

In accordance with a further aspect of this invention, the method of identifying objects comprises feeding objects into the identification system, scanning the objects to capture images of the objects, attempting to recognize regions of interest on the objects, directing the captured images with unrecognized regions of interest to the external processor, attempting to decode the recognized regions of interest by the imaging system, directing the captured images with undecoded regions of interest to the external processor, attempting to recognize the regions of interest unrecognized by the imaging system and to decode the undecoded regions of interest by the external processor and directing the objects with the decoded regions of interest of the captured images out of the system.

In accordance with a further specific aspect of this invention, labels are printed for the objects with the decoded regions of interest of the captured images and an operator is notified of objects with undecoded regions of interest. Further the regions of interest may be symbology, barcodes, text, graphics or shapes.

Other aspects and advantages of the invention, as well as the structure and operation of various embodiments of the invention, will become apparent to those ordinarily skilled in the art upon review of the following description of the invention in conjunction with the accompanying drawings.

### BRIEF DESCRIPTION OF THE DRAWINGS

The invention will be described with reference to the accompanying drawings, wherein:

FIG. 1 is a flowchart representation of a prior art package processing system;

FIG. 2 is a block diagram illustrating an embodiment of the present invention;

FIG. 3 illustrates the functional blocks of the imaging system of the present invention;

FIG. 4 is a flowchart representation of an embodiment of the present invention;

FIG. 5 is a flowchart representation of a further embodiment of the present invention using parallel processing;

FIG. 6 is an example of one type of object to be identified; and

FIG. 7 is a schematic of a handheld object inspection system.

### DETAILED DESCRIPTION

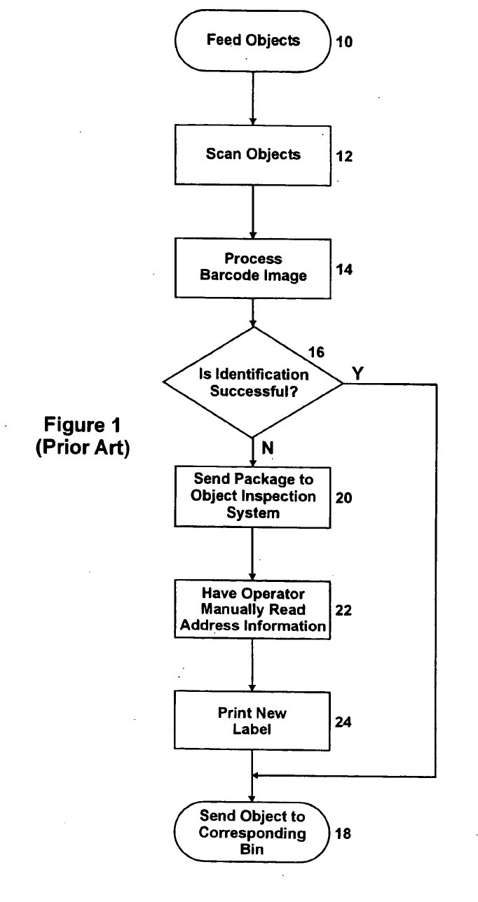

FIG. 1 is a flowchart that illustrates a prior art object inspection processing system, which will be described as one that recognizes markings on objects and is capable of sorting and processing those objects. The system feeds 10 the objects onto a conveyor belt for example, scans 12 them with a symbology scanner, and processes 14 each image acquired. If the processed image is recognized 16 because the address information is readable and correct, for example, the object is sent 18 to its predetermined destination such as a bin, which corresponds to the address information. Preferably, the scanning is accomplished in a single pass and does not require further processing. However, often the processed image is not recognized and the object cannot be processed 16 due to incorrect or damaged symbology, the object is then diverted to an object inspection system 20, which could include a bin or another conveyor belt. Depending on the system used, the diverted objects are either handled manually by an operator to visually determine the correct address, or viewed by an operator remotely 22, using a CCTV system for example. In the latter case, an operator views the diverted object on a video screen and manually types in the appropriate information. The operator prints a new label 24 and resorts the object, sending 18 it to its corresponding bin.

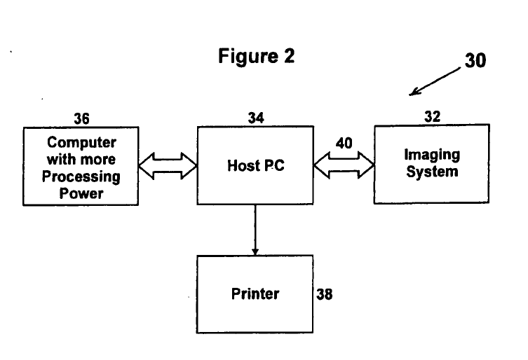

An embodiment of an object identification system 30 in accordance with the present invention is illustrated in FIG. 2. The system 30 includes an imaging system 32 to image and identify most objects such as symbology, barcodes, text, graphics or shapes, that pass before it. Since the imaging system 32, with its image processing and recognition capabilities, may not be able to recognize all of the objects, the image data is further transferred to an external host PC 34 through a bi-directional high speed communications interface 40. For example, if the object to be recognized is a bar code and it is not readable by the imaging system, the external host PC 34 which may be loaded with OCR software reads the written block of information on the object that is not identified by the imaging system itself The host PC 34 may further include operating functions for controlling the imaging system 32 and may further be coupled to a computer having more processing power 36 of the object processing system to provide object information to it for directing the objects to their destinations. Alternately, host PC 34 may be coupled to a printer 38 for providing a proper label, such as an address label, for the object that has been identified.

The imaging system 32 is preferably an electronic camera, which could be a CMOS imager, a CCD camera or other electronic imaging device that are well known in the art. The imaging system 32 advantageously also has a number of processor controlled features such as exposure control, illumination and targeting control incorporated into the camera system. Furthermore the imaging system 32 also includes image-processing capabilities. This feature can be used for example, in bar-code decoding applications, which would allow the imaging system to perform certain functions such as locating, capturing and storing an image of the object, as well as decoding the aspect of the object to be recognized, verifying the results, and transmitting and receiving instructions from the host PC 34. Furthermore, through the bi-directional high-speed communications interface 40, the imaging system 32 is capable of transmitting/receiving data to and from the host PC 34 which, because of its superior processing capabilities, will quickly identify most objects that are not identified by the camera.

The host PC 34 is preferably any personal computer that has been programmed to interface with an imaging system 32. Host PC systems are well known in the art, and any person skilled in the art would be able to provide such a system.

The high-speed interface 40 of the present invention may be USB 2.0, Firewire, Gigabit Ethernet or any other suitable, bi-directional high-speed interface. The interface 40 links the imaging system 32 to the host PC 34 and advantageously has a data rate of at least 200 Mb per second. If the processor in the imaging system 32 cannot successfully decode an image, the image is transmitted to the host PC 34 via the high-speed interface 40 for further processing, including OCR processing of the address information by the host PC 34.

The label printer 38, connected to the host PC 34, prints out new labels containing the correct address information as determined by the decoding and processing steps described above. The new label is placed on the package, which is subsequently resorted and sent to the bin corresponding to the address information.

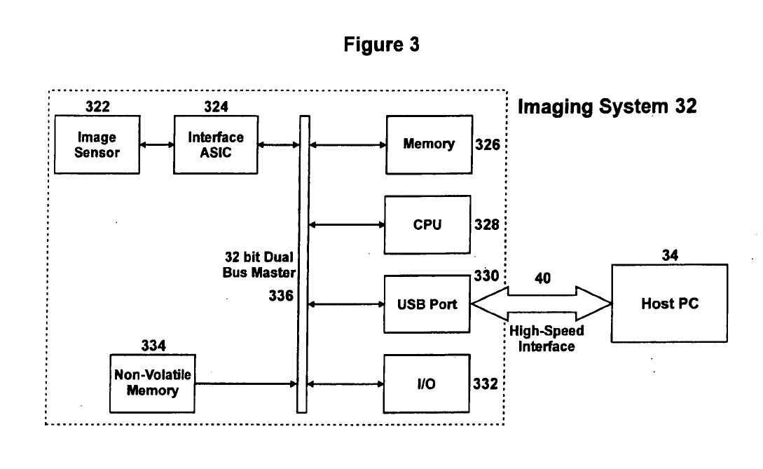

An imaging system 32 of the type used in the present invention, is illustrated in FIG. 3 and comprises an image sensor 322, an image sensor processor 324, a memory 326 for storing the image, a central processing unit 328, non-volatile memory 334 for storing application specific software, a general purpose I/O 332 attached to a user interface, and a 32 bit dual bus master (DMA) 336 for accessing each functional block within the imaging system 32. A USB port 330, for example, permits connection to the host PC 34 via a high-speed interface 40 having a data throughput rate of approximately 200 Mb per second.

A further advantage of using an imaging system 32 is the ability of the microprocessor 328 to determine the region of interest on the package, such as the region on the package containing the pertinent information such as an address or a symbol. By intelligently narrowing the field of view (FOV) to only include the region of interest (ROI), both latency and transmission times are reduced. Imaging systems 32 also provide more local features including automatic exposure control and image quality compensation. An imaging system 32, which narrows the FOV to include only the region of interest on the package and provides extra processing features, may be all that is required to identify the object such as the symbology on some diverted objects.

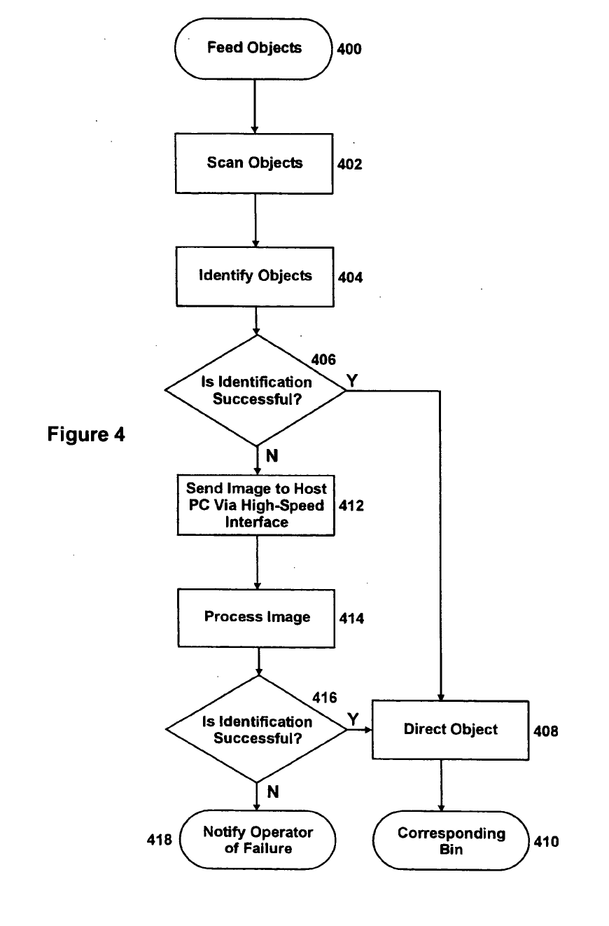

FIG. 4 is a flow chart representation of the object identification process of the present invention. An object is fed 400 into the system 30, the object inspection system 32 optically scans 402 the target and an image of the target is stored in the temporary memory 326 before being downloaded to the processor 328 for evaluation. An attempt to identify the object 404 is made. If the object identification is successful 406, the object is directed 408 to its destination such as its corresponding bin, if it is not successful 406, the stored image is sent 412 via the high-speed interface 40, to the host PC 34 for further image evaluation and processing 414. If the image is identified 416 by the host PC 34, the object is directed 408 to its destination such as its corresponding bin. If however, on the rare occasion, the object cannot be identified 416, an operator is notified of the failure 418 by a visual or auditory notification system.

Except in the rare cases where the object is completely unidentifiable due to severe damage, missing data or incorrect data, this method virtually eliminates the need for an elaborate object inspection system, to evaluate the object and manually enter the correct information. Therefore, the need for human intervention and the chances for human error are greatly reduced.

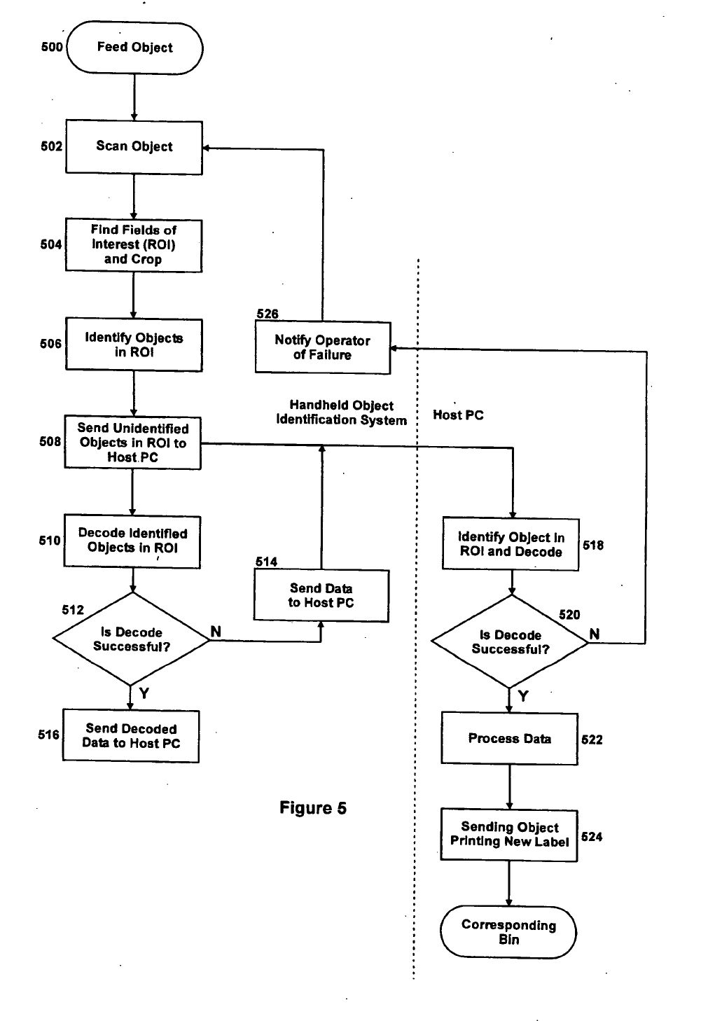

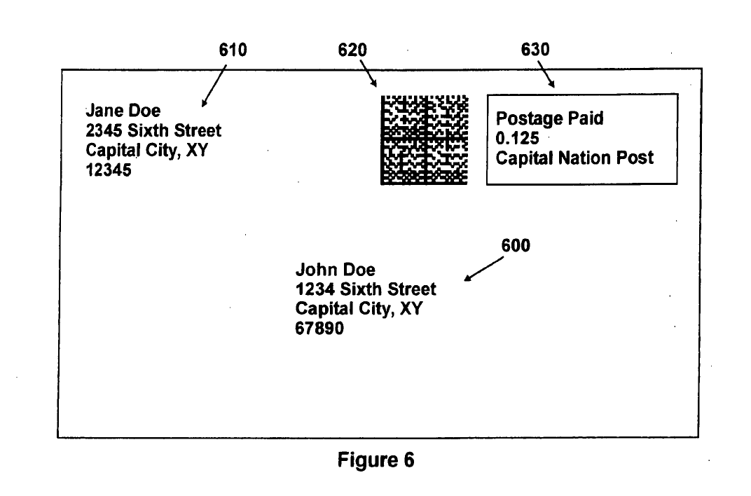

FIG. 5 is a flowchart representation of another embodiment of the present invention. Parallel processing is used to improve the speed at which the image data is processed for object identification. Similar to the first embodiment described above, the object is fed 500 into the object identification system 30, the imaging system 32 optically scans 502 the target and an image of the target is stored in the temporary memory 326 before being downloaded to the processor 328 for evaluation. An example of one type of object to be identified is shown in FIG. 6. Using this example, the imaging system 32 determines the areas of interest on the object by finding 504 the address field 600, the return address field 610, a DataMatrix bar code 620 and some postage information 630, and it crops these portions, known as the region of interest (ROI), out of the overall image. Then the imaging system 32 makes an attempt 506 to recognize each ROI; if the image is unrecognizable 508 it is forwarded to the host PC 34. If the ROI is recognized as a symbology that the imaging system 32 has been programmed to decode, then the imaging system 32 attempts to decode the image 510. If the imaging system 32 is however not able 512 to decode the ROI, it forwards 514 the undecoded ROI to the host PC 34. If the imaging system 32 is able 512 to decode the ROI, it then forwards 516 the decoded data to the host PC 34.

Meanwhile, as the imaging system 32 is working to decode the symbology, the host PC 34 has been able to initiate decoding 518 of unknown ROI. If the host PC 34 is able 520 to decode the ROI, it processes 522 the decoded data, sending 524 the object to its corresponding bin or printing a new label. The processing step can consist of verifying the data by comparing it to existing databases of information, or comparing the PC 34 decoded data with the imaging system 32 decoded data to ensure that both are in agreement. If the host PC 34 is not able to decode the data, the host PC 34 notifies 526 the operator of failure by activating the failure indicator in the imaging system 32. The operator then has the option of rescanning 502 the object to begin the process over again, or he/she can choose to remove the package from the system if the operator does not think the object can be identified by the system.

Therefore, after the image has been optically scanned 502 the imaging system 32 can be performing a number of functions such as location of barcode within the image, decoding the barcode or handling other tasks, while the host PC 34 is concurrently processing the image, verifying OCR results and the like, and printing a new address label. At step 512 and 520 queries are used to determine if decoding or OCR processing are successful or not. If the decode/OCR processing are not successful, the operator is notified 526 and appropriate action can be taken, but if the decoding and/or OCR processing are successful, a new label is generated 524 and placed on the package which can subsequently be resorted by the package sorting system and sent 524 to the corresponding bin. Parallel processing significantly improves the speed of the overall process in handling the end to end process.

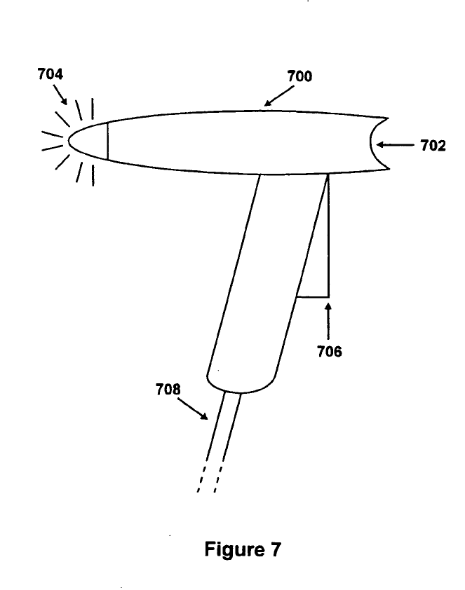

In another embodiment, FIG. 7 describes a handheld object inspection system. The system comprises an imaging system 702 contained within a handheld unit 700. The handheld unit 700 also has a user interface 704 for displaying information and a trigger 706 that is responsive to the user. The trigger 706 interfaces through the imaging system 702 to the host PC through a cable 708 to indicate that the user wishes to capture an image, the host PC will then issue a ready signal when appropriate to the imaging system 702. The imaging system 702 upon initiating the image capture sequence makes the appropriate exposure control and illumination changes, and captures an image. Image data is collected by the imaging system 702 and, in view of the image processing intelligence programmed into the imaging system 702, some image identification processing will take place either before or during transmission of image data to the host PC via 708, which would enable the parallel processing embodiment as discussed earlier in the specification. Once the image data has been received by the host PC, the host PC examines the image data according to how it has been programmed. This may include inspecting the image for evidence of damage to the object, incorrect form factors, incorrectly placed logos, etc. The specific image recognition algorithm being performed is not the intention of this disclosure, and a variety of algorithms for performing these tasks based on image data are well known in the art, and so will not be further described here.

The user interface 704 is preferably an LED that may be activated to indicate a pass or left blank to indicate a fail, or vice-versa. The user interface 704 can incorporate far more complex embodiments; it could be several LEDs to indicate a variety of statuses to the user, such as Ready, Wait, Pass, Fail, or Retake; or it could be an LCD panel which may incorporate communication to indicate the current processing, or potential errors and even present the image data to the user that is being analyzed. A person skilled in the art could see a variety of other manners by which the user interface may be employed and still fall within the intended spirit of the invention.

the trigger 706 is preferably a common mechanical trigger as would be known in the industry. A button, a touch sensitive pad, or a switch could in other embodiments replace the trigger 706, a person skilled in the art can imagine a plurality of other mechanisms by which a trigger may be employed and still fall within the intended spirit of the invention.

The present invention advantageously uses the processing power in the imaging system as well as the host PC together with a high speed interface between the two to provide an object identification system that is capable of identifying objects to a high degree, virtually eliminates the need for an operator and significantly reduces the time losses involved in the various types of existing object inspection systems.

While the invention has been described according to what is presently considered to be the most practical and preferred embodiments, it must be understood that the invention is not limited to the disclosed embodiments. Those ordinarily skilled in the art will understand that various modifications and equivalent structures and functions may be made without departing from the spirit and scope of the invention as defined in the claims. Therefore, the invention as defined in the claims must be accorded the broadest possible interpretation so as to encompass all such modifications and equivalent structures and functions.

What is claimed is:

1. A system for identifying objects comprising:
an imaging system for capturing images of the objects, the imaging system including a processor having means for identifying certain objects from the captured images;
an external processor having image recognition means for identifying the objects from the captured images; and
a high speed communications link coupling the imaging system and the external processor for carrying captured image data from the imaging system to the external processor.

2. A system for identifying objects as claimed in claim 1 wherein the imaging system further includes means for transmitting the captured images of the objects unidentified by the imaging system to the external processor.

3. A system for identifying objects as claimed in claim 1 wherein the imaging system further includes means for transmitting the captured images of the objects to the external processor.

4. A system for identifying objects as claimed in claim 1 wherein the imaging system comprises:
an image sensor;
an image processor;
a high speed port; and
a bus linking the sensor, image processor and the port.

5. A system for identifying objects as claimed in claim 4 wherein the imaging system comprises:
a memory for storing the captured images;
a memory for storing application software; and
a user interface.

6. A system for identifying objects as claimed 5 in claim wherein the imaging system is contained in a handheld unit.

7. A system for identifying objects as claimed in claim 1 wherein the imaging system is an electronic camera.

8. A system for identifying objects as claimed in claim 7 wherein the electronic camera is a CMOS imager.

9. A system for identifying objects as claimed in claim 7 wherein the electronic camera is a CCD camera.

10. A system for identifying objects as claimed in claim 1 wherein the objects are symbology, barcodes, text, graphics or shapes.

11. A system for identifying objects as claimed in claim 1 wherein the objects have regions of interest.

12. In an object identification system, having an imaging system, an external processor and a high-speed link coupling the imaging system and the processor, a method of identifying objects comprising:
passing the objects before the imaging system;
capturing images of the objects;
directing the imaging system to identify certain of the objects from the images;
transmitting images of the objects to the external processor; and
directing the external processor to identify the objects from the transmitted images.

13. The method of identifying objects as claimed in claim 12 comprising transmitting all of the captured images of the objects to the external processor.

14. The method of identifying objects as claimed in claim 12 comprising transmitting the captured images of the objects unidentified by the imaging system to the external processor.

15. The method of identifying objects as claimed in claim 12 wherein the objects are symbology, barcodes, text, graphics or shapes.

16. The method of identifying objects as claimed in claim 12 wherein the objects have regions of interest.

17. In an object identification system, having an imaging system, an external processor and a high speed link coupling the imaging system and the processor, a method of identifying objects comprising:
passing the objects before the imaging system;
capturing images of the objects;
identifying certain of the objects by the imaging system from the captured images;
transmitting the images of the unidentified objects to the external processor; and
identifying the unidentified objects by the external processor.

18. In an object identification system, having an imaging system, an external processor and a high speed link coupling the imaging system and the processor, a method of identifying objects comprising:
feeding objects into the identification system;
scanning the objects to capture images of the objects;
attempting to identify the objects from the captured images;
directing the objects of the identified images out of the system;
directing the remaining unidentified images to the external processor;
attempting to identify the remaining images by the external processor; and
directing the objects of the identified remaining images out of the system.

19. The method of identifying objects as claimed in claim 18 comprising notifying an operator of objects unidentified by the external processor.

20. The method of identifying objects as claimed in claim 19 wherein the objects are symbology, barcodes, text, graphics or shapes.

21. The method of identifying objects as claimed in claim 19 wherein the objects have regions of interest.

22. The method of identifying objects as claimed in claim 19 comprising printing labels for the the objects of the identified remaining images.

23. In an object identification system, having an imaging system, an external processor and a high speed link coupling the imaging system and the processor, a method of identifying objects comprising:
feeding objects into the identification system;
scanning the objects to capture images of the objects;
attempting to recognize regions of interest on the objects;
directing the captured images with unrecognized regions of interest to the external processor;
attempting to decode the recognized regions of interest by the imaging system;
directing the captured images with undecoded regions of interest to the external processor;
attempting to recognize the regions of interest unrecognized by the imaging system and to decode the undecoded regions of interest by the external processor; and
directing the objects with the decoded regions of interest of the captured images out of the system.

24. The method of identifying objects as claimed in claim 23 comprising notifying an operator of objects with undecoded regions of interest.

25. The method of identifying objects as claimed in claim 23 wherein the regions of interest are symbology, barcodes, text, graphics or shapes.

26. The method of identifying objects as claimed in claim 23 comprising printing labels for the objects with the decoded regions of interest of the captured images.
